(19) United States
(12) Patent Application Publication
(10) Pub. No.: US 2024/0034626 A1
(43) Pub. Date: Feb. 1, 2024

(54) METHOD FOR PREPARING HIGH PERFORMANCE LITHIUM IRON PHOSPHATE NANOPOWDER

(71) Applicants: Robert Brian Huang, Las Vegas, NV (US); Richard Brian Huang, Las Vegas, NV (US)

(72) Inventors: Robert Brian Huang, Las Vegas, NV (US); Richard Brian Huang, Las Vegas, NV (US)

(73) Assignee: Watix Technology LLC, Las Vegas, NV (US)

(21) Appl. No.: 18/226,763

(22) Filed: Jul. 26, 2023

Related U.S. Application Data
(60) Provisional application No. 63/392,283, filed on Jul. 26, 2022.

(51) Int. Cl. C01B 25/45; H01M 4/58; H01M 4/62

(52) U.S. Cl. CPC C01B 25/45; H01M 4/5825; H01M 4/625; C01P 2002/52; C01P 2004/64; C01P 2004/80; C01P 2006/40; C01P 2002/72; C01P 2004/03

(57) ABSTRACT

This method prepares high performance lithium iron phosphate nanopowder, used in the construction of cathode material for lithium ion batteries. The preparation comprises the following steps: (a) the synthesis of iron hydrogen phosphate (FeHPO₄) by mixing high purity nano-size metal iron powder (Fe) and phosphoric acid (H₃PO₄) in solution, (b) addition of a water-soluble lithium source and carbon source to the previous solution to yield a slurry (M−1), and (c) the (M−1) slurry being milled, spray dried, heat treated, and magnetically filtered to obtain a lithium iron phosphate nanopowder. The preparation method is simple, has low cost, and produces a high performance lithium iron phosphate nanopowder with high purity, high conductivity, cycling stability, and comprehensive electrochemical performance.

### CROSS-REFERENCE TO RELATED APPLICATION

This application claims the benefit of the U.S. Provisional Patent Application No. 63/392,283, filed Jul. 26, 2022, which is incorporated by reference herein in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention relates to the field of chemical processing technology, in particular to methods for preparing lithium iron phosphate.

### Description of Related Art

In recent decades, as demand for portable electronic devices have increased, lithium ion batteries have gained widespread popularity as a method of rechargeable energy storage due to their high energy density, long cycle life, and good performance at high rates.

In particular, batteries containing lithium iron phosphate (LiFePO₄) cathodes provide better capacity, voltage, volume density, high temperature stability, and energy cost basis when compared to other cathode types, such as the more commonly used lithium cobalt oxide (LiCoO₂).

Current known methods for preparing the lithium iron phosphate material include a hydrothermal synthesis method, a supercritical hydrothermal synthesis method and a glycothermal synthesis method. The hydrothermal synthesis and supercritical hydrothermal synthesis processes require high pressures and high temperatures during the synthesis, which produce safety concerns and increase costs. The glycothermal synthesis method has difficulty controlling particle size and particle size distribution, which are necessary to maximize capacity and conductivity.

Other known methods process the lithium iron phosphate reactants all at once. Such a conglomeration of reactants increases the potential of contamination within the final product by trace metals, which reduces the yield and purity of the final product, ultimately decreasing the conductivity and capacity retention of the final cathode material.

In a similar vein, existing methods use mostly phosphate and iron salt to produce iron phosphate. Compared to direct production of iron phosphate by iron and phosphate, production of iron phosphate by phosphate and iron salt requires more time, consumes more energy, and generates by-product salts that are difficult to remove, resulting in the final product containing significant impurities.

Finally, other methods may simply require more steps, equipment, or material than necessary to produce a lithium iron phosphate cathode material that does not perform as proportionally well to warrant such additional costs.

### BRIEF SUMMARY OF THE INVENTION

An aspect of the present invention provides a method for preparing a high performance lithium iron phosphate nanopowder using a three step reaction process. The sequential steps involve (a) the synthesis of iron hydrogen phosphate (FeHPO₄) by mixing high purity nano-size metal iron powder (Fe) and phosphoric acid (H₃PO₄) in solution, (b) addition of a water-soluble lithium source and carbon source to the previous solution to yield a slurry (M−1), and (c) the (M−1) slurry being milled, spray dried, heat treated, and magnetically filtered to obtain a lithium iron phosphate nanopowder.

According to the method for preparing a lithium iron phosphate nanopowder of the present invention, a reaction may be performed under low pressure and temperature conditions, thereby reducing safety concerns common in the hydrothermal or supercritical hydrothermal synthesis, while maintaining uniform particle size and particle distribution necessary for maximizing capacity. Furthermore, by producing iron phosphate in a separate step, and then adding lithium and carbon, a more uniform lithium iron phosphate nanopowder with less impurities is produced, overall increasing conductivity and capacity when compared to single step methods. Furthermore, by producing iron phosphate using metal iron powder and phosphoric acid, a more uniform lithium iron phosphate nanopowder with less impurities is produced, overall increasing conductivity and capacity when compared to using iron salts and phosphates. Finally, the presented method significantly minimizes steps to reduce the cost of equipment, material, and time while still producing a cathode material with excellent electrical conductivity, cycling stability, and comprehensive electrochemical performance.

### BRIEF DESCRIPTION OF THE DRAWINGS

FIG. 1 reports the charge and discharge curves at different rates (0.2 C, 1 C) and the specific capacity (mAh/g) of each curve of a half cell constructed using the lithium iron phosphate nanopowder prepared according embodiment 1 of the present invention.

FIG. 2 reports the charge and discharge curves at different rates (0.2 C, 1 C, 10 C) and the capacity retention rate (%) of each curve of a half cell constructed using the lithium iron phosphate nanopowder prepared according embodiment 1 of the present invention. These curves were produced after 100 cycles of the battery.

FIG. 3 is an X-ray diffraction (XRD) pattern of the lithium iron phosphate nanopowder prepared according to an embodiment 1 of the present invention.

FIG. 4 is a scanning electron microscope (SEM) photographic image taken at ×10000 magnification of the lithium iron phosphate nanopowder prepared according to embodiment 1 of the present invention.

### DETAILED DESCRIPTION OF OF THE INVENTION

In the present invention, a method for preparing high performance lithium iron phosphate nanopowder using a three step reaction process is described. The sequential steps involve (a) the synthesis of iron hydrogen phosphate (FeHPO₄) by mixing high purity nano-size metal iron powder (Fe) and phosphoric acid (H₃PO₄) in solution, (b) addition of a water-soluble lithium source and carbon source to the previous solution to yield a slurry (M−1), and (c) the (M−1) slurry being milled, spray dried, heat treated, and magnetically filtered to obtain a lithium iron phosphate nanopowder.

Such a method resolves the high costs and lower conductivity brought about in prior art by introducing fewer steps, producing a more pure product, and reducing safety risks.

### Step 1—Synthesis of FeHPO₄

First, a nano-size metal iron powder (Fe) and phosphoric acid (H₃PO₄) are prepared and mixed in an aqueous solvent to yield a solution of iron hydrogen phosphate (FeHPO₄) (S1). This step is carried out under rapid stirring at 40-98° C. for 0.5-3 hrs to better homogenize the solution and increase the yield of iron hydrogen phosphate (FeHPO₄). Furthermore, the pH is maintained at 1.3-1.7 by addition of water or phosphoric acid.

Preferably, the nano-size metal iron powder is 0.1-2 um in size. Preferably, the iron content of the described iron powder is 99.0%-99.9%.

Preferably, the mass percentage of the phosphoric acid is 20-35%.

Preferably, the mixing molar ratio of the metal iron powder to phosphoric acid during the formation of the solution is 1:1-2.

The aqueous solvent is water, which has a high boiling point. Preferably, the amount of water is an amount that makes the mass percentage content of iron in the system 2-5%.

Preferably, immediately after step 1, a filtering step is conducted to extract insoluble metal iron powder of the solution. Then, additional phosphoric acid or deionized water is added into the resulting solution to maintain a pH of 1.3-1.7. Performing this step improves the overall yield and purity of the iron hydrogen phosphate by removing unreacted iron powder.

By using iron powder and phosphoric acid as raw materials, the production of by-product salts and anions is reduced, resulting in lower energy consumption from impurity treatments and a higher purity of iron hydrogen phosphate. A purer iron hydrogen phosphate will decrease the overall impurity found in the final lithium iron phosphate product, thereby increasing its conductivity.

### Step 2—Addition of Lithium and Carbon

Second, a lithium source and a carbon source are added to the resulting (S1) solution to yield a slurry (M−1) of unactivated lithium iron phosphate and the carbon source. This step is carried out under rapid stirring at 40-98° C. for 0.5-3 hrs.

In an embodiment, the lithium source is selected from the group consisting of lithium carbonate (Li₂CO₃), lithium acetate dihydrate (CH₃COOLi·H₂O), lithium hydroxide monohydrate (LiOH·H₂O), lithium hydroxide (LiOH), lithium oxalate (Li₂C₂O₄), or a combination thereof, which are soluble in water.

Preferably, the molar ratio of Li:Fe during the formation of lithium iron phosphate is 1.03:1.

In an embodiment, the carbon source is selected from the group consisting of glucose, sucrose, cellulose, dextrose monohydrate, polyethlyene glycol, polyvinyl alcohol, soluble starch, monocrystal/polycrystal crystal sugar, fructose, vinyl pyrrolidone, poly(sugar alcohol), polymethacrylate, or a combination thereof, which are soluble in water and do not contain anion compounds. Preferably, the carbon source is a combination of dextrose monohydrate and polyethylene glycol.

Preferably, the carbon source is in an amount of 0.1-10 mass % of the theoretical lithium iron phosphate within the solution.

In an embodiment, a doping agent is added to increase the conductivity of the lithium iron phosphate. Preferably, the doping agent is titanium dioxide (TiO₂). Preferably, the doping agent is an amount of 0.1-0.5 mass % of the theoretical lithium iron phosphate within the solution.

The pressure and temperature conditions in step 1 and step 2 do not require a high pressure or a high temperature resistant vessel. Rather, the above steps are performed at temperature ranges from 40-98° C. and at around standard atmospheric pressure. As a result, the method improves process safety and economic feasibility.

### Step 3—Additional Synthesis Processes

The (M−1) slurry is milled to a particle size of around 300 nm (D50). The milled slurry is spray dried and then heat treated at 600-700° C. for 7-40 hrs in an inert atmosphere to obtain activated lithium iron phosphate coated with carbon additive nanopowder. The powder is subsequently sifted to reduce clumping and magnetically filtered to remove any remaining metal impurities.

The presented method for preparing the lithium iron phosphate nanopowder may be performed at non-extreme pressure and temperature conditions, thereby reducing safety concerns and costs. Furthermore, the decoupling of iron phosphate and lithium iron phosphate synthesis produces an overall more pure product, thereby improving conductivity of the final product. In addition, despite the simplicity and small degree of material usage, the prepared lithium iron phosphate nanopowder, when used to construct a lithium-ion battery, demonstrates excellent electrical conductivity, cycling stability, and comprehensive electrochemical performance.

### PREFERRED EMBODIMENTS

In order to promote the understanding of the present disclosure, the disclosure will be described below in detail, with reference to some preferred embodiments. It should be understood that the embodiment is merely illustrative, and is not intended to limit the scope of the present disclosure. Any changes, modifications and replacements made by those skilled in the art without departing from the spirit of the disclosure should fall within the scope of the disclosure defined by the claims.

### Embodiment 1

115.3 g of 85% phosphoric acid (H₃PO₄) was dissolved into 374.7 g distilled water (dH2O) to obtain 500 mL of 20% phosphoric acid and the solution was heated to 45° C. 22.3 g of 0.5 um metal iron powder (Fe) was added into the heated solution and the solution was stirred for 1.5 hrs to dissolve the metal iron powder. The solution was filtered and additional phosphoric acid was added to set the pH of the resulting solution to 1.5. The primary reaction was:

Fe+H₃PO₄=FeHPO₄+H₂

16.8 g of lithium hydroxide monohydrate (LiOH·H₂O), and 0.945 g glucose (C₆O₆H₁₂) was added into the resulting solution to yield a slurry of unactivated lithium iron phosphate and the carbon source. The primary reaction was:

3FeHPO₄+3LiOH·H₂O=3LiFePO₄+6H₂O

The resulting slurry was milled to a particle size of 300 nm (D50). The milled slurry was spray dried and the resulting powder was heat treated in a furnace at 700° C. for 12 hours under a nitrogen (N₂) atmosphere. The reaction product, a lithium iron phosphate compound with a carbon coating, was subsequently sifted, magnetically filtered, and analyzed with X-ray diffraction spectroscopy and a scanning electron microscope.

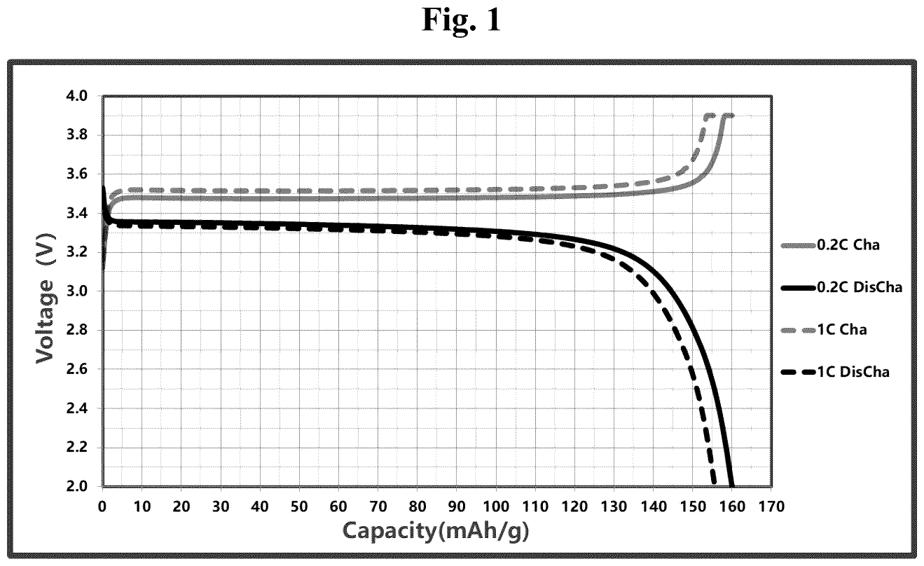

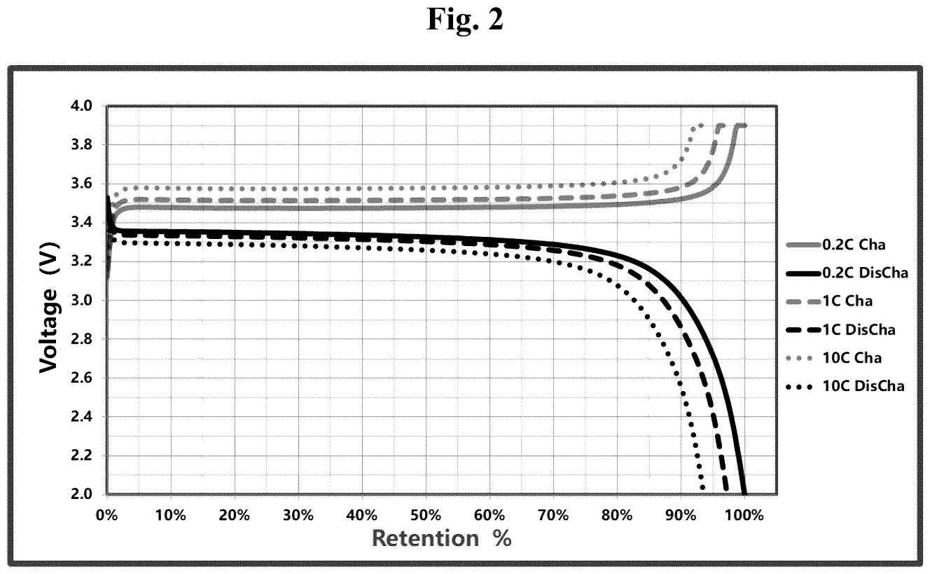

To measure the product's performance within a battery, a lithium iron phosphate half cell was constructed using industry standard methods with the lithium iron phosphate produced by the present method. The discharge specific capacities of the lithium iron phosphate half cell prepared by this embodiment, according to FIG. 1, are 159.87 mAh/g and 153 mAh/g at current densities 0.2 C and 1 C respectively. Furthermore, according to FIG. 2, the capacity retention rates are 99.9% at 0.2 C and 97.6% at 1 C after 100 cycles. The lithium iron phosphate material prepared therefore has high specific capacity, good conductivity, and excellent rateability performance.

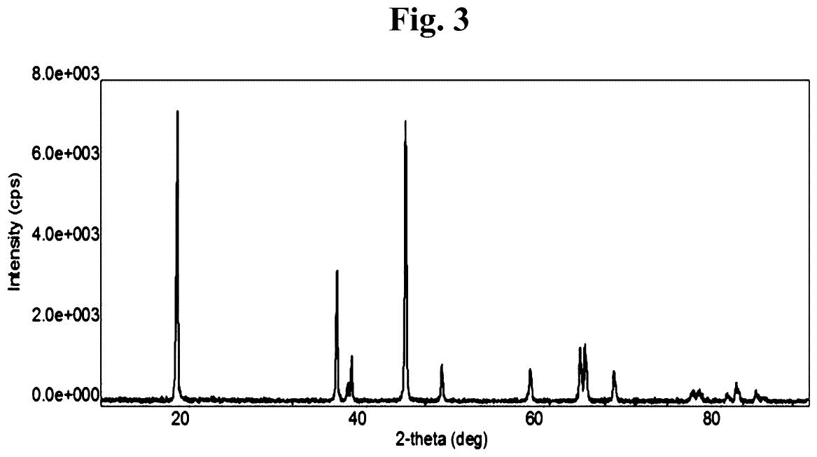

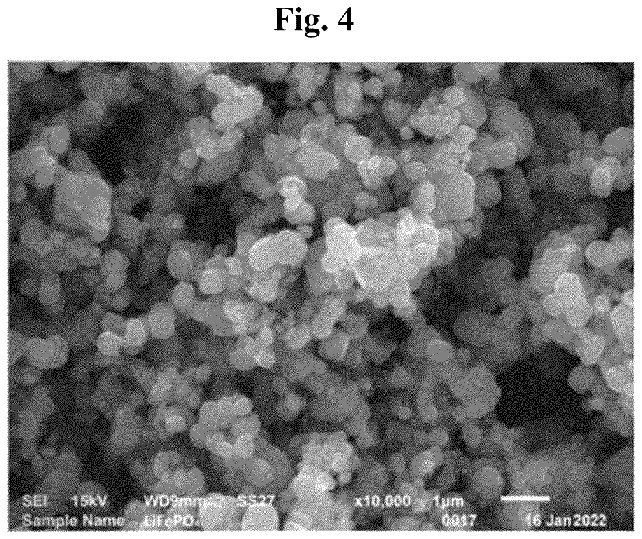

Based on electron scanning microscopy images in FIG. 4, the particles within the compound demonstrate sizes of 100-250 nm, which is significantly smaller than industry average particle sizes of 300-500 nm. Furthermore, the particles are uniform and present with few impurities. The x-ray diffraction, featured in FIG. 3, corroborates that the final product is highly pure lithium iron phosphate nanopowder.

As shown in the embodiment, despite the simplicity and small degree of material usage, the lithium iron phosphate nanopowder prepared has small and uniform particle size, uniform particle structure, excellent electrical conductivity, cycling stability, and comprehensive electrochemical performance.

### Embodiment 2

115.3 g of 85% phosphoric acid (H₃PO₄) was dissolved into 374.7 g distilled water (dH₂O) to obtain 500 mL of 20% phosphoric acid and the solution was heated to 60° C. 22.3 g of 1 um metal iron powder (Fe) was added into the heated solution and the solution was stirred for 1.5 hrs to dissolve the metal iron powder. The solution was filtered and additional phosphoric acid was added to set the pH of the resulting solution to 1.5. The reaction was:

Fe+H₃PO₄=FeHPO₄+H₂

14.8 g of lithium carbonate (Li₂CO₃), 1.45 g glucose (C₆O₆H₁₂), 1 g polyethylene glycol 5000 (PEG5000), and 0.044 g titanium dioxide (TiO₂) was added into the resulting solution to yield a slurry. The reaction was:

2FeHPO₄+Li₂CO₃=2LiFePO₄+CO₂+H₂

The resulting slurry was milled to a particle size of 300 nm (D50). The milled slurry was spray dried and the resulting powder was heat treated in a furnace at 700° C. for 12 hours under a nitrogen (N₂) atmosphere. The reaction product, a lithium iron phosphate compound with a carbon coating, was subsequently sifted, magnetically filtered, and analyzed with X-ray diffraction spectroscopy and a scanning electron microscope.

To measure the product's performance within a battery, a lithium iron phosphate half cell was constructed using industry standard methods with the lithium iron phosphate produced by the present method. The discharge specific capacity of the half cell is 151 mAh/g at 1 C. Furthermore, the capacity retention rate is 96.9% at 1 C after 100 cycles. The lithium iron phosphate material prepared therefore has high specific capacity, good conductivity, and excellent rateability performance.

Based on electron scanning microscopy images, the particles within the compound demonstrate sizes of around 350 nm, which is similar to the industry average particle sizes of 300-500 nm.

As shown in the embodiment, despite the simplicity and small degree of material usage, the lithium iron phosphate nanopowder prepared has small and uniform particle size, uniform particle structure, excellent electrical conductivity, cycling stability, and comprehensive electrochemical performance.

1. A method for the preparation of lithium iron phosphate nanopowder, which is characterized by the following sequential steps:
(S1) mixing together iron powder, phosphoric acid, and water;
the iron powder of which has a iron content between 99.0% and 99.9% and a particle size (D50) between 0.1 um and 2 um;
(S2) mixing together the resulting solution of (S1), a lithium source, and a carbon source;
the lithium source of which is water soluble;
the carbon source of which is water soluble and does not release anion compounds while in solution;
(S3) having the resulting slurry of (S2) sequentially undergo a milling step to a particle size of 250-300 nm (D50), a spray drying step, a heat treatment step, a sifting step, and a magnetic filtration step.

2. A method for the preparation of lithium iron phosphate nanopowder of claim 1, in which during step (S1), the mixing molar ratio of the metal iron powder to phosphoric acid is 1:1-2.

3. A method for the preparation of lithium iron phosphate nanopowder of claim 1, in which during step (S1), the solution's pH is maintained at 1.3-1.7 by addition of water or phosphoric acid.

4. A method for the preparation of lithium iron phosphate nanopowder of claim 1, in which, after step (S1) but prior to step (S2), a filtering step is conducted to extract insoluble metal iron powder and then additional phosphoric acid or water is added into the filtrate to maintain a pH of 1.3-1.7; the filtrate of which becomes the “resulting solution” in step (S2).

5. A method for the preparation of lithium iron phosphate nanopowder of claim 1, in which step (S1) and step (S2), or step (S1) or step (S2), are carried out under rapid stirring at 40-98° C. for 0.5-3 hrs.

6. A method for the preparation of lithium iron phosphate nanopowder of claim 1, in which during step (S2), the lithium source is lithium carbonate (Li₂CO₃), lithium acetate dihydrate (CH₃COOLi·H₂O), lithium hydroxide monohydrate (LiOH·H₂O), lithium hydroxide (LiOH), lithium oxalate (Li₂C₂O₄), or a combination thereof.

7. A method for the preparation of lithium iron phosphate nanopowder of claim 1, in which during step (S2), the carbon source is glucose, sucrose, cellulose, dextrose monohydrate, polyethlyene glycol, polyvinyl alcohol, soluble starch, monocrystal/polycrystal crystal sugar, fructose, vinyl pyrrolidone, poly(sugar alcohol), polymethacrylate, or a combination thereof.

8. A method for the preparation of lithium iron phosphate nanopowder of claim 1, in which during step (S2), an amount of titanium dioxide (TiO₂) equal to 0.1-0.5 mass of the theoretical lithium iron phosphate of the mixture is also mixed together with the other chemicals.

9. A method for the preparation of lithium iron phosphate nanopowder of claim 1, in which, during step (S3), the heat treatment step is conducted at 600-700° C. for 7-40 hrs in an inert atmosphere.
